(19) United States
(12) Patent Application Publication
(10) Pub. No.: US 2020/0294407 A1
(43) Pub. Date: Sep. 17, 2020

(54) Educational electronic baby "play" mat

(71) Applicant: Chitunda Tillman, SR., Chicago, IL (US)

(72) Inventor: Chitunda Tillman, SR., Chicago, IL (US)

(21) Appl. No.: 16/501,248

(22) Filed: Mar. 13, 2019

(51) Int. Cl. G09B 5/06; A47D 13/00; A47G 27/02; G09B 1/16

(52) U.S. Cl. CPC G09B 5/062; A47D 13/00; A47G 2200/14; G09B 1/16; A47G 2200/08; A47G 27/0243

(57) ABSTRACT

An educational electronic baby mat having means for auditory and visual responses to user motion or pressure stimuli including a top layer having a plurality of symbols inscribed on a plurality of light transmitting zones adapted to be compressed by a baby or child thereby impacting middle layer light diffusers. The light diffusers impact electrical conducting contacts that impinge upon contact points located within electrical circuits on a flexible printed circuit board to activate indicator lights and auditory recitations associated with each compressed symbol. Alternatively, a motion sensor detects a baby or child's movements and preprogrammed sound and visual responses indicating the identity of top layer symbols are activated. A USB port and/or a wireless connection allows the transfer of data concerning use of the Play Mat by the baby or child from the microprocessor of the flexible circuit board to a handheld device, such as a phone or tablet.

### BACKGROUND OF THE INVENTION

### Field of Invention

The present invention relates to a mat or pad, and more particularly to a baby teaching mat displaying symbols, such as letters and numerals that are expressed visually and orally in response to activity performed by a baby or small child in contact with the mat.

### Background of the Invention

It is well known that babies or small children crawl, sit, and play on mats, and are attracted by colors and pictures displayed on a mat surface and objects attached to the mat covering. There are mats that produce sounds to soothe and amuse a baby or small child placed on the mat. The present invention contemplates an Educational Electronic Baby Play Mat having symbols such as letters and numerals on the mat surface, so that pressure or motion activated light and sound devices associated with each letter and numeral emit light and broadcast the identity of the symbol that is pressed. As the baby or small child moves about on the mat, it will repeatedly hear and see a certain symbol. This repetition will teach the baby or small child the identity of the symbol.

### DESCRIPTION OF THE PRIOR ART

Decorated mats for babies and children that produce sound in response to pressure are well known. For example, U.S. Pat. No. 5,784,733 discloses a child's blanket equipped with a small, musical sounding device with a manually operated switch and timing device to control the sound duration. U.S. Pat. No. 4,841,587 describes a transportable mat having a stereo sound system built directly into a pillow portion of the mat. U.S. Pat. No. 3,378,948 contemplates an elongated cylindrical pillow having a plurality of bells mounted either within or on the pillow. U.S. Pat. No. 2,994,889 describes a mat or pad for a child containing cells with sound units that are actuated by air to produce a whistling noise when the cells are depressed. Although the above mentioned patents disclose mats or pads that produce sounds from pressure stimulus, none of the mats or pads provide a simultaneous combination of light and sound when pressure is applied to a mat or pad area nor do they provide a choice between a motion sensor mode or a pressure actuated mode.

It is therefore a primary object of the present invention to provide an infant or child's mat that displays light and sound when the infant or child presses a particular symbol on the mat and to provide a choice between motion or pressure modes of operation.

Another object of the invention is to provide a symbol teaching device for an infant or child that can be used to teach such symbols as alphabet letters and numerals by reinforcing audibly and visually the names and appearance of the letters and numerals.

An additional object of the invention is to provide an early childhood teaching device that will give children a head start in learning basic skills necessary for success in school and life.

Another object of the invention is to hold a child's attention and entertain a child with meaningful words and symbols.

Another object of the invention is to allow the Educational Electronic Baby Play Mat to be taken along with children when travelling by way of a virtual application, which allows users to follow through on the child's Learning Continuum when on the go.

Another object of the invention is to track the neuroplasticity of a child when using the Educational Electronic Baby Play Mat.

Accordingly, there is an unmet need for a symbol teaching device for an infant or child in the form of a mat that displays light and sound when the infant or child presses a particular symbol, which can be used to teach such symbols as alphabet letters and numerals by reinforcing audibly and visually the names and appearance of the letters and numerals, and that further allows the symbol teaching device to be taken along with children when travelling by way of a virtual application, and/or is capable of tracking the neuroplasticity of the infant or child.

### SUMMARY OF THE INVENTION

To achieve the above stated objectives, the present invention includes an Educational Electronic Baby Play Mat responsive to pressure applied by a crawling baby or walking toddler. As pressure is applied to a symbol displayed on the mat surface, the symbol's identity is heard and the symbol is illuminated. In the alternative, a motion sensor detects the presence of a baby or toddler and responds with a preprogrammed audio and visual presentation.

The mat of the present invention comprises a top layer having a plurality of symbols inscribed on the top layer surface, a middle layer flexible printed circuit board with indicator lights surrounded by light diffusing structures and a wear resistant padded bottom layer. The top layer surface symbols are placed on a plurality of spaced apart transparent and/or translucent light transmitting zones for optimum light transmission. In a preferred embodiment a plurality of molded projections from the top layer bottom surface directed toward a middle layer provide compartments that receive middle layer light diffusion structures. Alternatively, light diffusion structure compartments may be achieved by sewing, attaching with Velcro, or using other securing means to connect the perimeter of the middle layer light diffusion structures to the perimeter of the top layer symbol zones. In addition, the top layer symbol zones can be recessed to telescopically receive the middle layer light diffusion structures. The middle layer flexible printed circuit board is secured to the bottom layer with staples, by sewing, or other securing means.

In a preferred embodiment, the flexible circuit board provides appropriate memory, functionality, and capacity, such as a microprocessor, audio and visual circuitry, means for producing auditory sounds such as a sound synthesizer, a sound amplifier, a speaker, light drivers and light sources, a motion sensor, a dual mode on off switch, and/or a rechargeable power source. The visual circuitry can include 555 timing circuits that can operate to pulse and turn light sources off and on. All of the above electronic parts and structures are already well known in the art. The dual mode on off switching means and a power supply housing are advantageously accessed on the mat bottom where an adult, and not a baby or small child, can easily make contact. The dual mode on off switching means comprises a double throw switch so that a center position turns the mat audio and visual on or off and remaining switch positions can place the mat in a motion sensor mode or a pressure point actuation mode.

In the motion sensor mode, motion from a moving mat user detected by a motion sensor can activate preprogrammed audible responses such as alphabet letter recitations in ascending order, A, B, C, D, or in random order, R, C, P, S, along with a simultaneous visual display of the corresponding letters. Numerals, vowels, and consonants are additional symbols for audible recitation of their identities and simultaneous visual actuation. Colors, shapes and animal figures that appear as the mat surface artwork may also be appropriately programmed, thereby teaching a small child the name and/or configuration of the symbol. A plurality of symbols and a plurality of colors are available for the educational mat surface artwork and simultaneous sound and light identification. Sound programming can be accomplished in a variety of languages. When the baby or child's motion ceases, soothing music such as a lullaby can ensue.

In the pressure point actuation mode, pressure from a crawling baby or walking toddler on a mat symbol or symbol zone causes voice actuation that identifies the symbol and light actuation that highlights the symbol. Microprocessor timer circuitry such as standard 555 circuits provide a preset time duration and automatic shut off for light operation and steady or pulsating light signals. If the baby or child applies pressure to several symbols or symbol zones nearly simultaneously, the microprocessor can be designed to activate individual lights and voice identification in the order pressed, even if the time difference is as small as a millisecond, and play back the voice and light signals at a slow pace, about every second or second and a half, so that the baby or child can comprehend and learn the symbol.

In other embodiments of the invention, an Educational Electronic Baby Play Mat as described above but with a single mode switch can include only the motion sensor mode or, in the alternative, only the pressure point actuation mode.

In any of the aforementioned embodiments of the Educational Electronic Baby Play Mat, a Universal Serial Bus (USB) port and/or a wireless connection such as Wi-Fi or Bluetooth allows the transfer of data concerning use of the Educational Electronic Baby Play Mat by the baby or small child from the microprocessor of the flexible circuit board to a handheld device, such as a phone or tablet. In this way, the Educational Electronic Baby Play Mat allows certain functionality to be performed when travelling (i.e. —“on the go!”) or when it is otherwise inconvenient to transport or access the Educational Electronic Baby Play Mat itself. Specifically, by using a USB port and/or a wireless connection to transfer of data concerning use of the Educational Electronic Baby Play Mat by the baby or small child, it is possible to determine whether the baby or small child has completed a task pre-programmed into the Educational Electronic Baby Play Mat.

Data concerning the task, which may be a lesson or series of lessons, can be transferred to the handheld device, where it may be stored and/or integrated into an application. The application may allow a user to determine errors and make adjustments to the lesson or series of lessons in real time. Further, the application may allow the user to adjust the skill level of the Educational Electronic Baby Play Mat based on the strengths and weaknesses of the baby or small child. In this way, an adult can follow through on the progress of the baby or small child with regards to its Learning Continuum. Furthermore, the application may be capable of determining and tracking the developing baby or child's neuroplasticity. Neuroplasticity is defined as “the capacity for continuous alteration of the neural pathways and synapses of the living brain and nervous system in response to experience . . . ” Merriam-Webster, 949, 11th ed., 2003.

The mat perimeter can be configured in geometric shapes such as a square or a rectangular shape, and in additional embodiments the mat can have ring shaped, circular, oval, or serpentine configurations. The Educational Electronic Baby Play Mat top layer can be constructed of pliable waterproof padded material that is quilted for durability with symbols placed on transparent and/or translucent light transmitting zones, preferably of a flexible plastic like material. The bottom layer can also be padded with access to the dual mode on off switching means and to the power source. The mat can be sized to fit a floor area, a crib or bed or to fit the particular needs of a certain user.

### BRIEF DESCRIPTION OF THE DRAWINGS

The above-mentioned and other features of embodiments of the Educational Electronic Baby Play Mat, and the manner of their working, will become more apparent and will be better understood by reference to the following description of embodiments of the Educational Electronic Baby Play Mat taken in conjunction with the accompanying drawings, wherein:

FIG. 1 is a top plan view of an embodiment of the Educational Electronic Baby Play Mat showing symbols, symbol zones, visual and auditory components, and a USB port and/or Wi-Fi, as described herein;

FIG. 2 shows a sectional view of a light diffusion and electrical contact structure taken along line 2-2 of FIG. 1, as described herein;

FIG. 2A shows a sectional view of a light diffusion and electrical contact structure taken along line 2-2 of FIG. 1 after pressure has been applied to a symbol or symbol zone, as described herein;

FIG. 3 is a block diagram showing audio and visual circuitry disposed in a flexible circuit board of the Educational Electronic Baby Play Mat, including a USB PORT and/or wireless connection, as described herein;

FIG. 4 is a partial bottom perspective view of the Educational Electronic Baby Play Mat showing switching means and power source housing placement, as described herein; and

FIG. 5 is a top plan view of an alternative embodiment of the Educational Electronic Baby Play Mat having a ring shaped configuration, as described herein.

Corresponding reference numbers indicate corresponding parts throughout the several views. The exemplifications set out herein illustrate embodiments of the Educational Electronic Baby Play Mat, and such exemplifications are not to be construed as limiting the scope of the claims in any manner.

### DETAILED DESCRIPTION

The following detailed description and appended drawing describe and illustrate various exemplary embodiments of the invention. The description and drawings serve to enable one skilled in the art to make and use the invention, and are not intended to limit the scope of the invention in any manner. In respect of the methods disclosed and illustrated, the steps presented are exemplary in nature, and thus, the order of the steps is not necessary or critical.

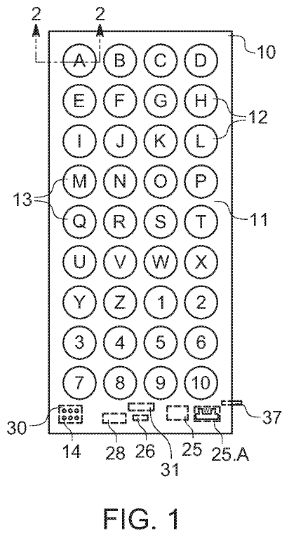

Referring to FIG. 1, the Educational Electronic Baby Play Mat 10 comprises a mat top layer 11 having a plurality of spaced apart transparent and/or translucent light transmitting zones 12, either colored or clear, surrounding a plurality of symbols 13 and speaker output perforations 14. The plurality of symbols 13 can be displayed in a medley of colors or black and white or a combination of color and black and white. Word, letter and numeral symbols can be in a variety of fonts, languages, and printing styles. In a preferred embodiment of the present invention, the plurality of symbols 13 consist of twenty six letters of the English alphabet and numerals one through ten.

The mat top layer 11 can be fabricated of a padded waterproof plasticized material, quilted or not quilted. In addition, the mat top layer 11 can be a soft material such as flannel, corduroy, or chenille that is padded and quilted. The transparent and/or translucent colored lenses that are placed over plurality of spaced apart transparent and/or translucent light transmitting zones 12 to change colors can be supplied.

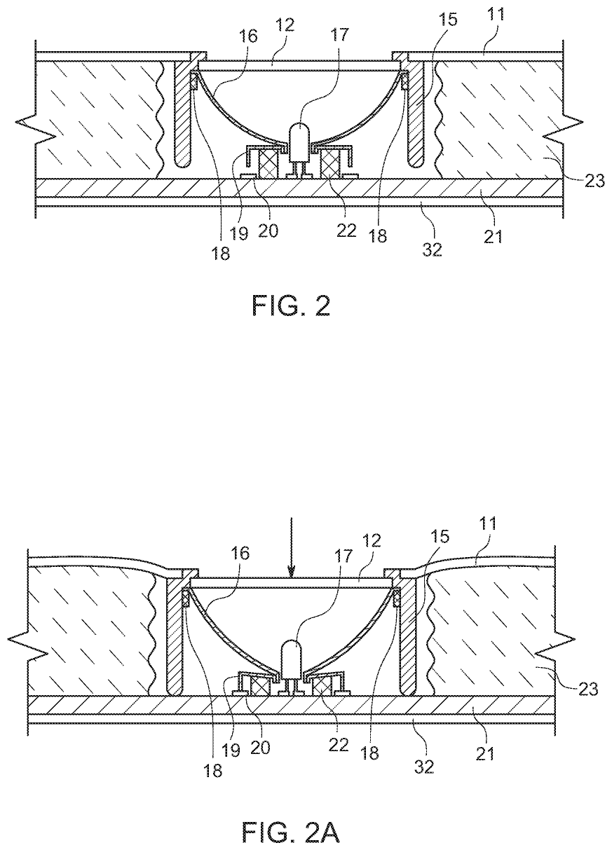

Referring to FIG. 1 and FIGS. 2 and 2A, which are sectional views taken along line 2-2 of FIG. 1, the Educational Electronic Baby Play Mat 10 mat top layer 11 bottom surface has a plurality of compartment creating projections 15 directed toward a middle layer. A plurality of compartments are arranged so that each compartment holds a cup shaped light diffuser 16 having an indicator light source 17 such as a light emitting diode or an incandescent filament bulb contained within the cup shaped light diffuser 16 and wired to an electronic printed circuit. The cup shaped light diffuser 16 is secured to the plurality of compartment creating projections 15 by friction force for containment within a compartment. In the alternative, the cup shaped light diffuser 16 is secured to the plurality of compartment creating projections 15 with clamping springs 18. In addition, cup shaped light diffuser 16 can be telescopically inserted into the rim of a recessed spaced apart transparent and/or translucent light transmitting zone 12.

As illustrated in FIG. 2A, the cup shaped light diffuser 16, responding to pressure on a transparent and/or translucent light transmitting zone 12, can move to impinge adjacent electrical conducting contacts 19 on to oppositely disposed contact points 20 located on a middle layer flexible printed circuit board 21 and at the same time also compresses resilient blocks 22, which, upon pressure release, spring back into an original shape and position and thereby moving the cup shaped light diffuser 16 along with electrical conducting contacts 19 back to their original location as seen in FIG. 2. In place of resilient blocks 22, spring means for electrical conducting contacts 19 touch and release movement is appropriate. Plurality of compartment creating projections 15 can be constructed from a firm durable material such as dense polyethylene so that the plurality of compartment creating projections 15 upon compression of transparent and/or translucent light transmitting zones 12 act as stops to prevent damage to electrical conducting contacts 19 and oppositely disposed contact points 20. A soft resilient filler material 23 such as latex foam or sponge rubber can be placed between the middle layer flexible circuit board 21 and the mat top layer 11 in spaces between the plurality of compartment creating projections 15.

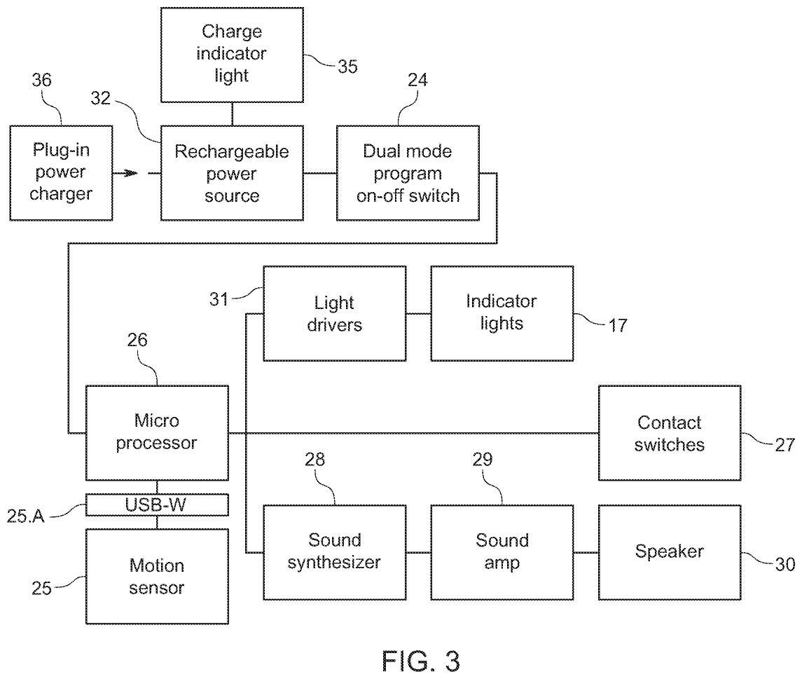

The middle layer flexible printed circuit board 21 is embedded with circuitry as illustrated in FIG. 3. A dual mode on off switch 24 providing selection of mode of operation allows a user to turn the Educational Electronic Baby Play Mat 10 on and off, to set the Educational Electronic Baby Play Mat 10 in a motion sensor 25 mode so that an infant's or child's motion will activate a microprocessor 26 on the middle layer flexible printed circuit board 21 to initiate a preprogrammed auditory and visual response, or to set the Educational Electronic Baby Play Mat 10 in a single point actuation mode where electrical conducting contacts 19 impinge on oppositely disposed contact points 20 to close contact switches 27 that activate microprocessor 26 to initiate audio and visual responses to the user's symbol 13 selections. The dual mode on off switch 24 or other means may further set the Educational Electronic Baby Play Mat 10 in a single point actuation mode where electrical conducting contacts 19 impinge on oppositely disposed contact points 20 to close contact switches 27 that activate microprocessor 26 to initiate audio only responses to the user's symbol 13 selections, without illumination of the indicator light sources 17.

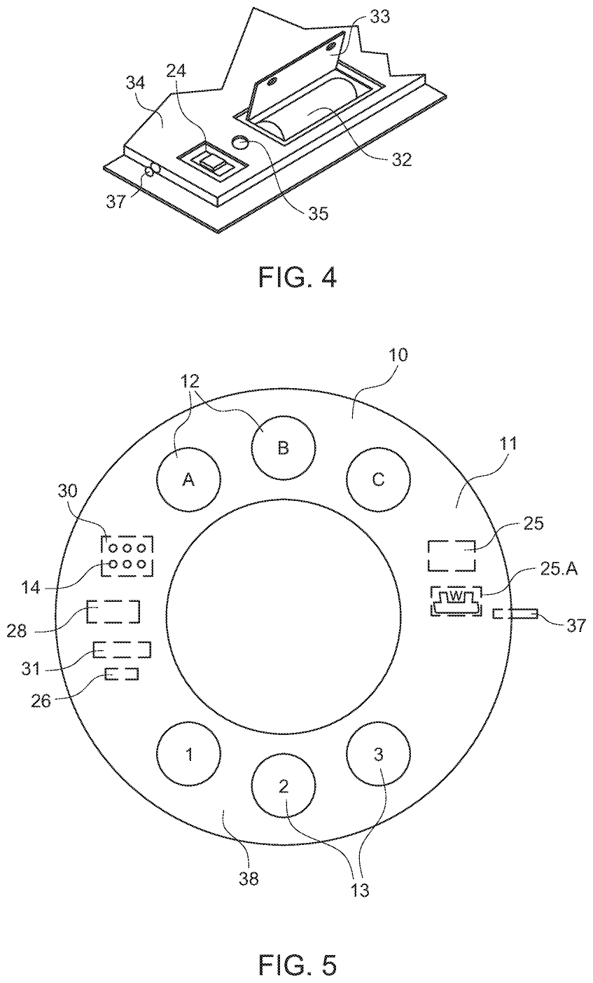

The microprocessor 26 provides logic that instructs a sound synthesizer 28 message that identifies activated symbols and provides appropriate music. The sound synthesizer message is amplified by a sound amplifier 29 and sent to a speaker 30 and microprocessor 26. Also, the microprocessor 26 activates light drivers 31 that amplify current to activate indicator light sources 17 which are affixed to middle layer flexible circuit board 21. A power source 32 has a housing 33 that opens where a mat bottom layer 34 lower surface meets a supporting surface such as a floor or bed and can be closed by screw means so that a baby or small child cannot come in contact with the power source 32 which can be a nickel cadmium battery, a nickel metal hydride battery, or any dry cell power pack. See FIG. 4. The dual mode on off switch 24 is also placed in the mat bottom layer 34 lower surface so an adult can control the Educational Electronic Baby Play Mat 10 dual mode on off switch 24. The power source 32 can be equipped with a charge light 35 and a plug in charger 36 equipped to be inserted into a charger port 37. The middle layer flexible circuit board 21 may further interface with a USB port and/or wireless connection 25A. In this way, the microprocessor 26 may transfer data concerning tasks, a lesson, or series of lessons to a handheld device, as described previously.

As illustrated in FIG. 5, in another embodiment of the invention, the Educational Electronic Baby Play Mat 10 is configured in a ring shape 38. In addition, an infinite number of geometric shapes including rectangular, square, circular, oval, and serpentine shaped mats can be constructed all with a plurality of spaced apart transparent and/or translucent light transmitting zones 12 and a plurality of symbols 13 inscribed therein, the middle layer flexible printed circuit board 21 with means for indicator light source 17 activation as illustrated in FIGS. 2, 2A, and FIG. 3, and mat bottom layer 34 with power source 32 and power source housing 33 along with the dual mode on off switch 24 as seen in FIG. 4.

A further embodiment of the invention comprises a single mode on off switch wherein the motion sensor 25 only activates auditory and visual responses or, in the alternative, a single mode on off switch provides visual and auditory responses only in a pressure point actuation mode as illustrated in FIGS. 2 and 2A.

While the Educational Electronic Baby Play Mat has been described with respect to at least one embodiment, the Educational Electronic Baby Play Mat can be further modified within the spirit and scope of this disclosure, as demonstrated previously. This application is therefore intended to cover any variations, uses, or adaptations of the Educational Electronic Baby Play Mat using its general principles. Further, this application is intended to cover such departures from the present disclosure as come within known or customary practice in the art to which the disclosure pertains and which fall within the limits of the appended claims.

REFERENCE NUMBER LISTING

| | |
|---|---|
| 10 | Educational Electronic Baby Play Mat |
| 11 | mat top layer |
| 12 | plurality of spaced apart transparent and/ |
| | or translucent light transmitting zones |
| 13 | plurality of symbols |
| 14 | speaker output perforations |
| 15 | plurality of compartment creating projections |
| 16 | cup shaped light diffuser |
| 17 | indicator light source |
| 18 | clamping springs |
| 19 | electrical conducting contacts |
| 20 | oppositely disposed contact points |
| 21 | middle layer flexible printed circuit board |
| 22 | resilient blocks |
| 23 | soft resilient filler material |
| 24 | dual mode on off switch |
| 25 | motion sensor |
| 25A | USB port and/or wireless connection |
| 26 | microprocessor |
| 27 | contact switches |
| 28 | sound synthesizer |
| 29 | sound amplifier |
| 30 | speaker |
| 31 | light drivers |
| 32 | power source |
| 33 | housing |
| 34 | mat bottom layer |
| 35 | charge light |
| 36 | plug in charger |
| 37 | charger port |
| 38 | ring shape |

1.-8. (canceled)

9. A Educational Electronic Baby Play Mat system configured to provide auditory and visual responses to user stimuli, comprising:
a mat having:
a top layer having a plurality of symbols inscribed on a plurality of spaced apart light transmitting zones on the surface of the top layer;
a middle layer having a plurality of indicator light sources within the plurality of spaced apart light transmitting zones;
a bottom layer having means for mode of operation switching, a power source, and a power source housing all mounted in the lower surface of the bottom layer;
a flexible circuit board having at least one microprocessor, the flexible circuit board being connected to at least one of a USB port and a wireless connection; and
a device for electrically actuating at least one of the indicator light sources and audible recitations, the device being at least one of a motion detector and a printed circuit; and
an application running on a handheld device;
wherein the flexible circuit board, the at least one microprocessor, and the at least one of a USB port and a wireless connection is configured to transfer data concerning use of the mat to the handheld device.

10. The Educational Electronic Baby Play Mat system of claim 9, wherein:
the flexible circuit board, the at least one microprocessor, and the at least one of a USB port and a wireless connection being further configured to transfer the data concerning use of the mat to the handheld device in real time.

11. The Educational Electronic Baby Play Mat system of claim 9, wherein:
the flexible circuit board, the at least one microprocessor, and the at least one of a USB port and
a wireless connection being further configured to transfer data concerning at least one of:
performance of pre-programmed tasks or lessons by the user, and
a skill level setting of the microprocessor.

12. The Educational Electronic Baby Play Mat system of claim 11, wherein:
the application being configured to at least one of:
determine completion of the pre-programmed tasks or lessons by the user,
determine errors committed by the user,
make adjustments to the pre-programmed tasks or lessons, and
adjust the skill level setting of the microprocessor.

13. The Educational Electronic Baby Play Mat system of claim 12, wherein:
the application being further configured to determine strengths and weaknesses of the user.

14. The Educational Electronic Baby Play Mat system of claim 13, wherein:
the application being further configured to track progress of the user.

15. The Educational Electronic Baby Play Mat system of claim 14, wherein:
the application being further configured to determine neuroplasticity of the user.

16. The Educational Electronic Baby Play Mat system of claim 9, further comprising:
a switch configured to control a setting of the Educational Electronic Baby Play Mat system, the setting being at least one of:
an on/off status,
a motion sensor mode,
a single point actuation mode,
an audio/visual mode,
a visual only mode, and
an audio only mode.

17. A method of teaching infants or children symbols using auditory and visual responses to user stimuli, comprising:
providing a mat having:
a top layer having a plurality of symbols inscribed on a plurality of spaced apart light transmitting zones on the surface of the top layer;
a middle layer having a plurality of indicator light sources within the plurality of spaced apart light transmitting zones;
a bottom layer having means for mode of operation switching, a power source, and a power source housing all mounted in the lower surface of the bottom layer;
a flexible circuit board having at least one microprocessor, the flexible circuit board being connected to at least one of a USB port and a wireless connection; and
a device for electrically actuating at least one of the indicator light sources and audible recitations, the device being at least one of a motion detector and a printed circuit; and
running an application on a handheld device;
configuring the flexible circuit board, the at least one microprocessor, and the at least one of a USB port and a wireless connection to transfer data concerning use of the mat to the handheld device.

18. The method of claim 17, further comprising the step of:
configuring the flexible circuit board, the at least one microprocessor, and the at least one of a USB port and a wireless connection to transfer the data concerning use of the mat to the handheld device in real time.

19. The method of claim 17, further comprising the step of:
configuring the flexible circuit board, the at least one microprocessor, and the at least one of a USB port and a wireless connection to transfer data concerning at least one of:
performance of pre-programmed tasks or lessons by the user, and
a skill level setting of the microprocessor.

20. The method of claim 19, further comprising the step of:
configuring the application to at least one of:
determine completion of the pre-programmed tasks or lessons by the user,
determine errors committed by the user,
make adjustments to the pre-programmed tasks or lessons, and
adjust the skill level setting of the microprocessor.

21. The method of claim 20, further comprising the step of:
configuring the application to determine strengths and weaknesses of the user.

22. The method of claim 21, further comprising the step of:
configuring the application to track progress of the user.

23. The method of claim 22, further comprising the step of:
configuring the application to determine neuroplasticity of the user.

24. The method of claim 17, further comprising the step of:
configuring a switch to control a setting of the mat, the setting being at least one of:
an on/off status,
a motion sensor mode,
a single point actuation mode,
an audio/visual mode,
a visual only mode, and
an audio only mode.
